(19) United States
(12) Patent Application Publication
(10) Pub. No.: US 2012/0109933 A1
(43) Pub. Date: May 3, 2012

(54) METHOD AND APPARATUS FOR FEDERATED SEARCH

(75) Inventor: Pavel KRAVETS, Ashdod (IL)

(73) Assignee: SAP Portals Israel Ltd, Ra'anana (IL)

(21) Appl. No.: 12/916,542

(22) Filed: Oct. 31, 2010

(51) Int. Cl. G06F 17/30

(52) U.S. Cl. 707/711; 707/E17.108

(57) ABSTRACT

A method and apparatus for searching data by a computing platform from two or more computerized data sources, comprising an indexing stage and a searching stage. The indexing stage comprising: retrieving data from at least an on-premise data source and an on-demand data source, identifying data related to an entity from the on-premise data source with data from the on-demand data source, merging the data from the on-premise data source with data from the on-demand data source, normalizing the data from the on-premise data source with data from the on-demand data source, and generating a first index comprising one or more mashed entities or one or more mashed relationships obtained from the on-premise data source and the on-demand data source. The searching stage comprising: receiving a query from a user, scanning the first index in accordance with the query, retrieving data from the first index, and outputting the data.

### TECHNICAL FIELD

The present disclosure relates to data indexing in general, and to a method and apparatus for collecting, indexing and mashing data from different sources, in particular.

### BACKGROUND

Computer users nowadays search and consume information from various sources on a daily basis, and sometime as often as multiple times a day.

Some of the sources are on-demand sources, which are generally available to the public, for example over the Internet. Generally, on-demand sources are not under the user's control but a user can generally access them whenever he or she desires to. A popular type of on-demand sources relates to social networks. A social network comprises structured data that relates to individuals or organizations, referred to as nodes, which are interconnected by one or more types of interdependency, such as friendship, kinship, common interest, financial exchange, likes, dislikes, beliefs, knowledge, prestige, or any other. A social network enables a user to explore a part of a network for which he or she has access according to the network policy. For example a person that participates in such network can view data related to another participant, wherein the data may depend on the relationships between the person and the other participant. Thus, a person may be able to access some or all of the available data related to other participant which indicated the person as an associate of some level, and only basic information such as name, related to other participants. Some social networks apply persistency rules, for example by forbidding a user to store on a persistent storage device information related to other users. Current search tools such as search engines may enable the retrieval of information from on-demand sources.

Other data sources, common especially in organizational environments, comprise on-premise sources, such as organizational databases, organizational charts, or the like which are owned, managed and optionally stored by the organization or by an entity in the organization's behalf. Such sources and their structure and contents are under the control of the organization, and may be of proprietary format.

Some on-premise data sources provide search options for retrieving information from the source in accordance with the relevant user privileges.

Some entities such as people, groups, organizations or the like may appear in sources of the two types. For example a team mate of a user may appear in one or more organizational databases which constitute on-premise sources, as well as in one or more on-demand systems, for example by having information organized for example in pages in one or more social networks.

There is thus a need in the art for improving search capabilities available to users of various data sources, and for enabling users to obtain more relevant and focused information.

### SUMMARY

A method and apparatus for searching data by a computing platform from at least two computerized data sources.

One aspect of the disclosure relates to a method for searching data by a computing platform from two or more computerized data sources, comprising: an indexing stage comprising: retrieving data from at least an on-premise data source and an on-demand data source; identifying data related to an entity from the on-premise data source with data from the on-demand data source; merging the data from the on-premise data source with the data from the on-demand data source; normalizing the data from the on-premise data source with data from the on-demand data source; and generating a first index for storing one or more mashed entities or one or more mashed relationships obtained from the on-premise data source and the on-demand data source; and a searching stage comprising: receiving a query from a user; scanning the first index in accordance with the query; retrieving data from the first index; and outputting the data. Within the method, the first index is optionally stored in the memory of the computing platform. The indexing stage can further comprise generating a second index corresponding to the on-premise data source or a third index corresponding to the on-demand data source. The searching stage can further comprise retrieving data from the second index or the third index. The searching stage can further comprise parsing the query received from the user. The indexing stage can further comprise determining relevancy of entities in the first index. The indexing stage can further comprise storing the first index in a persistent storage device in accordance with limitations imposed by the on-demand data source.

Another aspect of the disclosure relates to an apparatus for searching data from two or more sources, comprising: a data indexing component comprising: a retrieval component for retrieving data from at least an on-premise data source and an on-demand data source; an identification component for identifying data related to an entity from the on-premise data source with data from the on-demand data source; a merging component for merging the data from the on-premise data source with the data from the on-demand data source; a normalization component for normalizing the data from the on-premise data source with data from the on-demand data source; and a first index generation component for generating a first index comprising one or more mashed entities or one or more mashed relationships obtained from the on-premise data source and the on-demand data source, and a searching component comprising: a scanning component for scanning the first index in accordance with a query received from a user; a retrieving component for retrieving data from the first index; and an output component for outputting the data. Within the apparatus, the first index is optionally stored in a memory device of a computing platform executing a component of the apparatus. The indexing component can further comprise a relevancy determination component for determining relevancy of entities in the first index. The indexing component can further comprise a second index generator for generating a second index corresponding to the on-premise data source or a third index corresponding to the on-demand data source. The searching component can further comprise a data retrieval component for retrieving data from the second index or the third index. The searching component can further comprise a parser for parsing the query received from the user. The apparatus can further comprise a storage device for storing the first index in a persistent storage device in accordance with limitations imposed by the on-demand data source.

Yet another aspect of the disclosure relates to a computer readable storage medium containing a set of instructions for a general purpose computer, the set of instructions comprising: an indexing stage comprising: retrieving data from at least an on-premise data source and an on-demand data source; identifying data related to an entity from the on-premise data source with data from the on-demand data source; merging the data from the on-premise data source with the data from the on-demand data source; normalizing the data from the on-premise data source with the data from the on-demand data source; and generating a first index comprising one or more mashed entities or one or more mashed relationships obtained from the on-premise data source and the on-demand data source, and a searching stage comprising: receiving a query from a user; scanning the first index in accordance with the query; retrieving data from the first index; and outputting the data. Within the computer readable storage medium the first index is optionally stored in the memory of a computing platform executing the indexing stage. The indexing stage can further comprise generating a second index corresponding to the on-premise data source or a third index corresponding to the on-demand data source. The searching stage can further comprise retrieving data from the second index or the third index. The searching stage can further comprise parsing the query received from the user. The indexing stage can further comprise determining relevancy of entities in the first index.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic block diagram of an environment in which the disclosed method and apparatus is used;

FIG. 2 is a schematic block diagram of exemplary memory contents and data flow within the memory of a computing platform providing federated search;

FIG. 3 is a flowchart of the main steps in an exemplary embodiment of a method for federated search; and

FIG. 4 is an exemplary embodiment of federated search apparatus, which provides federated search.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is the generation of federated search results in response to a query entered by a user. Federated search relates to combining information from two or more data sources, wherein at least one of the data sources is an on-demand data source, and at least one other data source is an on-premise data source. Information federated, e.g., combined from two sources may provide new aspects of the same entity, for example professional information combined with personal information and thus reveal otherwise unknown connections.

Technical aspects of the solution can relate to an apparatus and method which retrieve data from the two or more data sources, combine, index and prioritize the data, store the data in accordance with the persistency rules of the data sources, and provide a user with the federated search results.

The apparatus and method may construct an in-memory index for each data source, whether it is an on-demand source or an on-premise source. The data source index contains the fields relevant for searches, pointers to actual data that was received from persistent storage, and some actual data stored in the index itself.

In addition a combination index is created which keeps in-memory representation of the mashed data and entities, i.e., data combined or changed by the user. Thus the combination index comprises elements or relationships combined from different sources in normalized manner, wherein the sources may include on-demand or on-premise data sources.

When searching for data, the indices representing the different data sources are searches to retrieve real-time data. The merged or mashed entities are retrieved from the combination index in association with their relevancy.

The data within the indices exists only in the context of the same user. Different users may view different data, due for example to different permissions, access lists or the like.

In order to mash the information, data identification is performed, which relates to identifying instances associated with the same entity in different data sources. For example, one data source can contain an a field named “ID”, while another data source can contain a field named “ID Number”, while both data sources refer to the same piece of data.

The data is then indexed, and optionally normalized in order to remove duplicate data appearing in two or more data sources. For example, if the same data source comprises an address, one of them is discarded.

In some embodiments of the disclosed subject matter, uniform user relevancy is created during indexing for each record or for each field, the uniform user relevancy reflecting the relevancy of the record or field to the search.

In some embodiments of the disclosed subject matter, the indices are kept in memory as long as the user session continues, so further searches do not require index re-construction.

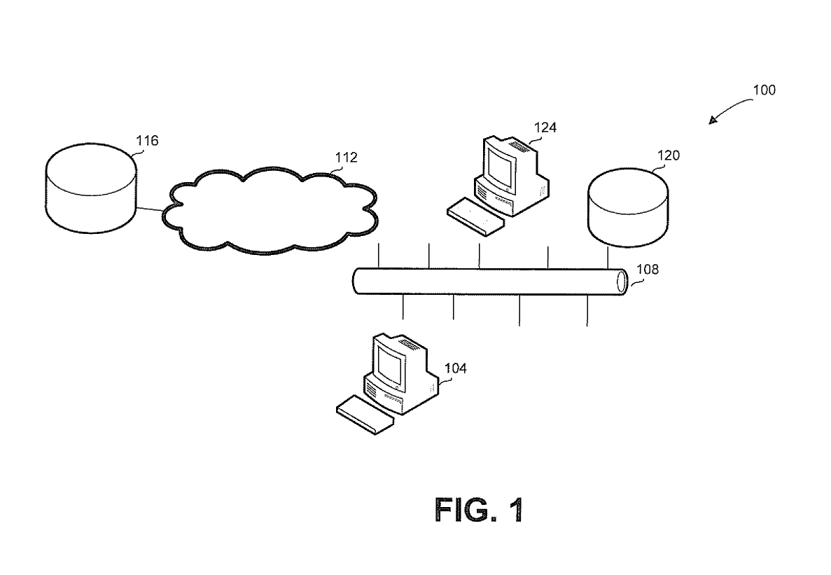

Referring now to FIG. 1, showing a schematic illustration of a typical environment in which the disclosed subject matter can be used.

The environment, referenced 100, comprises a user (not shown) using a computing platform 104, comprising a CPU and a memory device. Computing platform 104 can communicate with other entities via a channel 108 such as a local area network (LAN), wide area network (WAN), intranet, Internet, or others.

The entities with which computing platform 104 can communicate may include any further communication channel 112 such as the internet, which enables communication with storage 116, optionally via additional computing platforms. Storage 116 can comprise a data source from which the user wishes to retrieve information, such as an on-demand system for example a social network.

It will be appreciated by a person skilled in the art that storage 116 can be comprised of multiple storage devices and/or one or more servers for managing the storage.

The entities accessible to the user may also include entities on the same network, for example behind the same firewall. The entities may include storage device 120, optionally accessible through computing platform 124. Storage device 120 optionally stores an on-premise data source such as an HR database, an organizational chart, or the like, which contains information relevant for a group the user belongs to, such as an organization.

Some embodiments of the disclosed subject matter enable a user to issue a search request, and receive information that combines and mashes information from an on-demand data source and information from an on-premise data source. The data may be prioritized, so that records or fields having higher priority will be presented before records or fields having lower priority. The priority can be set, for example, in accordance with the number of fields matching between a record from the on-premise data source and a record from the on-demand data source.

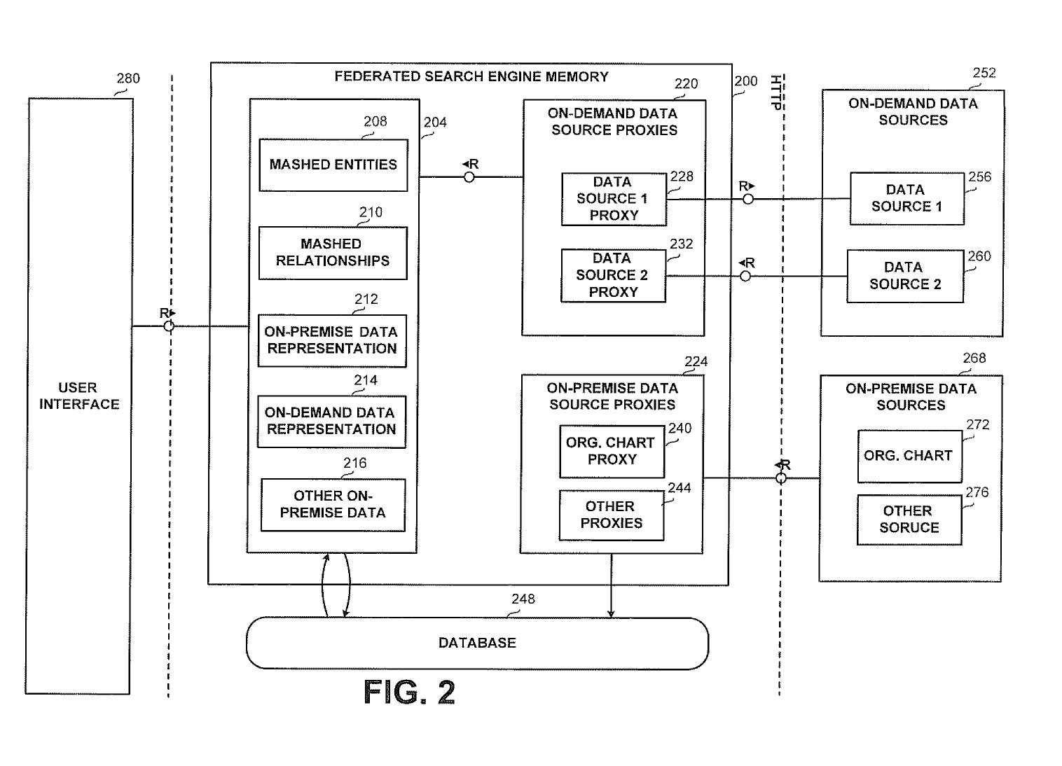

Referring now to FIG. 2, showing a schematic block diagram of exemplary memory contents and data flow within the memory of a computing platform enabling federated search.

The federated search is executed by a federated search engine, which utilizes memory space 200. Memory space 200 stores data 204. Data 204 contain actual data or pointers to data retrieved from the various data sources. Memory space 200 further stores on-demand data source proxies 220 for communicating with on-demand data sources 252, and on-premise data source proxies 224 for communicating with on-premise data sources 268.

On-demand data source proxies 220 contain a proxy for each on-demand data source the user receives information from. Thus, on-demand data source proxies 220 comprise data source 1 proxy 228 which communicates with data source 1 256, data source 2 proxy 232 which communicates with data source 1 260, or the like.

On-premise data source proxies 224 contain a proxy for each of on-premise data sources 268 the user receives information from. Thus, on-premise data source proxies 224 may comprise, for example, organizational chart proxy 240 which communicates with the organizational chart 272, or any other proxy 244 which communicates with any other data source 276. In some embodiments of the disclosed subject matter, each on-premise data source proxy can communicate with a single premise data source. In alternative embodiments, all or some of on-premise data source proxies 224 may communicate through a common channel with all or some of on-premise data sources 268.

Data 204 optionally comprises mashed entities 208 which are the entities found in two or more data sources, and their combined information, and mashed relationships 210 which comprises the relationships deduced from the multiple sources. For example, if the on-premise data source comprises information related to the team a person belongs to, and the on-demand data source comprises information related to the city a person lives in, then “team mates that live in the same city” is a mashed relation.

Data 204 also comprises on-premise data representation 212, which contains substantially the data received from any of on-premise data sources 268, such as organizational chart 272 or any other on-premise data source 276, as formatted during the search.

Data 204 further comprises on-demand data representation 214, which contains substantially the data received from any of on-demand data sources 252 as optionally formatted and changed during the search.

Some of the data such as data from any of on-premise data sources 268 may be stored in database 248. Data from on-demand data sources 252 may be stored in database 248 only in compliance with the data source policy. It will be appreciated that database 248 can be common to multiple users or for example to multiple users within an organization, so that each user performing new searches enriches the database and contributes to the database data that was retrieved for the user from on-demand data sources and new entities and relationships. Such data can then be available to future users from the organization.

Memory 200 communicates through any required protocol with user interface 280. As long as the interface or communication protocol between user interface 280 and the federated search engine does not change, user interface 280 can be changed without any effect on federated search engine and its performance.

It will be appreciated that although FIG. 2 indicates communication between memory contents such as proxies and other components, the communication flows through a processor, which is omitted for fluency of the description.

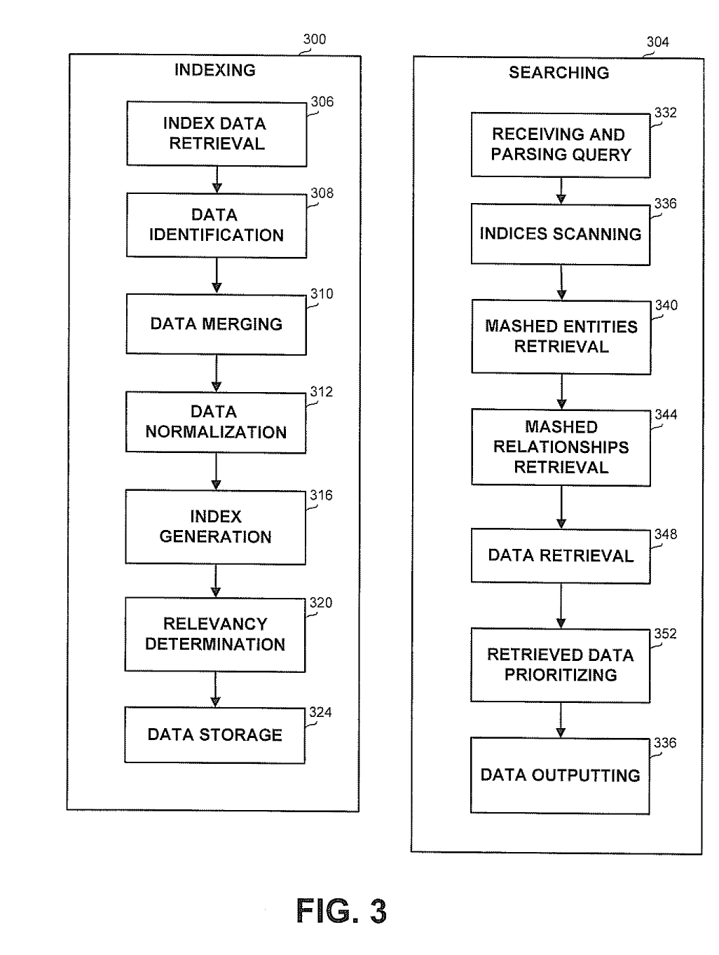

Referring now to FIG. 3, showing a flowchart of the main steps in an exemplary embodiment of a method for federated search.

The method comprises an indexing stage 300, and a searching stage 304. Upon the first search by a user in a particular session, indexing stage 300 takes place, followed by an occurrence of searching stage 304 for each search request by a user. Upon session termination followed by a further search, indexing stage 300 is repeated.

Indexing stage 300 comprises index data retrieval 306 in which data is retrieved from the various data sources, at least one of which is an on-premise data source such as an HR database, and at least one of which is an on-demand data source.

At data identification 308, identical or similar fields or records retrieved from two or more databases are identified with each other by corresponding fields, i.e., fields that refer to the same information although the field names may differ. Identification can use pre-configured correspondence or rules, or be dynamic and employ techniques such as string matching, pattern matching, regular expressions, or the like.

At data merging 310 the data is merged in accordance with the identical field, thus enriching the data. During merging, information from the two sources can be combined by merging records having the same value for the corresponding field.

Merging creates mashed entities, i.e., entities comprising information from two or more data sources, and mashed relationships, i.e. relationships deduced from information from two or more data sources. The merged information may also include relevancy information.

At data normalization 312, redundant data is removed. For example, if records relating to the same person have been retrieved from two data sources and identified as such in accordance with ID number, then it is enough to store the person's address just once although it may appear in the two data sources.

At index generation 316, an index is created per each data source from which information has been retrieved, the index comprising the searched fields, pointers to actual data, and optionally some actual data. Also generated at index generation 316 is a combination index that stores the mashed data, i.e., the mashed entities and mashed relationships.

The indices are in-memory and remain valid as long as the user session has not been terminated.

At relevancy determination 320 uniform user context relevancy is determined for the entities or entity types in the indices, the uniformity referring to assigning a relevancy measure to data retrieved from the federated search in accordance with user characteristics or preferences. Relevancy information can be stored as part of one or more indices or separately. The relevancy is uniform per user, so that the relevancy of various data items can be compared.

On data storage 324, the indices are optionally stored within a persistent storage device. The data received from the on-premise data sources can be stored without limitations, while the data received from the on-demand data sources can be stored in accordance with the limitations imposed by each particular data source.

Once indexing is done, searching stage 304 can take place, in order to provide information related to a particular search.

Searching stage 304 comprises query receiving and parsing 332. The query can be introduced via a dedicated user interface, through a file such as a text file or in any other manner. Depending on the query format, it may be parsed to convert it into format useable by the federated search engine.

At indices scanning 336, the combination index as well as the per-data-source indices are scanned in order to locate information corresponding to the query.

At mashed entities retrieval 340, data related to the mashed entities is retrieved, and at mashed relationships retrieval 344 data related to the mashed relationships is retrieved. The mashed entities and mashed relationships are retrieved from the combination index

At optional data retrieval 348 data is retrieved from each of the per-data-source indices.

At optional retrieved data prioritization 352 the data retrieved on mashed entities retrieval 340, mashed relationships retrieval 344 and data retrieval 348 is prioritized in accordance with the uniform relevancy determined at relevancy determination 320.

At data output 356 the retrieved and optionally prioritized data is output. The data can be output to any user interface via a required protocol, exported to a file, or otherwise output in any required manner.

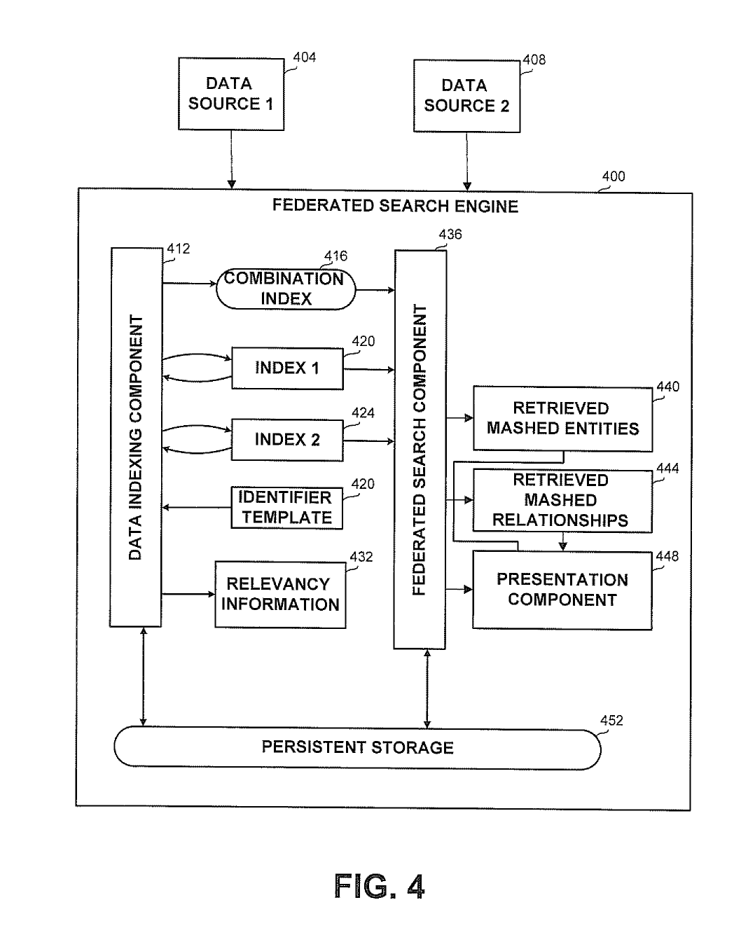

Referring now to FIG. 4, showing an exemplary embodiment of federated search apparatus 400, which enables federated search.

Federated search apparatus 400 combines and merges search results from different data sources, such as data source 1 (404) and data source 2 (408), one of which is an on-demand data source, such as a social network, and the other is an on-premise data source, such as the Human Resources (HR) database of an organization.

Federated search apparatus 400 comprises data indexing component 412 for indexing the data retrieved from the data sources so as to make it available for federated searches, performed by federated search component 436. The indexed data optionally remains available for the user throughout the session and multiple searches can be performed without further indexing.

Federated search apparatus 400 comprises data indexing component 412 for managing the data received from the various data sources, and indexing it. Data indexing component 412 is responsible for identifying corresponding fields in two or more data sources, i.e., fields that refer to the same information although the field names may differ. The field correspondence can be pre-configured, for example by a user indicating the correspondence, which may be stored in identifier templates 428. Alternatively, such correspondence can be deduced using techniques such as regular expressions, text matching, pattern matching or the like.

When such fields have been identified, information from the two sources can be combined by merging records having the same value for the corresponding field.

The merged information is optionally normalized, i.e., redundant or repeating information is removed.

During merging, a combination index 416 is created, as well as an index per each data source, such as index 1 (420) which relates to data source 1 (404), and index 2 (424) which relates to data source 2 (408). It will be appreciated that multiple indices can be created which relate to multiple data sources, and that the disclosed subject matter is not limited to two sources and two indices.

Each data-source-related index contains a field identifier for each searched field, pointers to actual data as received, whether it was received from the on-premise data source or from the on-demand data source from the data storage, and optionally some actual data.

Combination index 416 contains the mashed data, i.e., the data merged or changed by or for the user during the field correspondence and record merging. For example, combination index 416 may contain a list of fields or records deleted in order to avoid duplicate information.

Thus, the data-source-related indices such as index 1 (420) or index 2 (424) contain data as received from the data sources, while combination index 416 contains processed data, such as merging and normalization results.

The merging is optionally performed in accordance with a predefined order or rules, for example some fields may be matched before others, or some fields may not to be matched unless the field names are identical, or the like.

In some embodiments of the disclosed subject matter, data indexing component 412 may also be responsible for determining uniform user context relevancy, and generating user context relevancy information 432. User context relevancy information refers to a relevancy measure assigned to data retrieved from the federated search in accordance with user characteristics or preferences. For example, data retrieved from social networks that relates to people that work in the same organization as the user, can receive higher relevancy than data related to other people.

Other examples relate to users that work in the same collaborative network, users sitting physically in same room, people that have similar expertise such as sales manager, entities that connect people or other entities through an external source, such as people from different social networks that buy the same one or more books from an on-line book store, banking accounts that relate to the same transaction and vice versa, which can also be useful in detecting illegal issues. In some embodiments, the common entities can be used as for suggesting connections between different entities.

User context relevancy information 432 can be stored as part of one or more indices or separately. The relevancy is uniform per user, so that the relevancy of various data items can be compared.

Combination index 416 and indices 420 and 424 are stored in persistent storage 452 to the extent permitted by the on-demand data sources. For example, if no persistency is allowed, only data retrieved from the on-premise data sources is stored. If no persistency limitations apply, then the full contents of combination index 416 and indices 420 and 424 are stored in persistent storage 452.

It will be appreciated that in some embodiments data indexing component 412 can thus comprise the following components: a retrieval component for retrieving data from an on-premise data source and an on-demand data source, an identification component for identifying data related to an entity from the on-premise data source with data from the on-demand data source, a merging component for merging the data from the on-premise data source with data from the on-demand data source, a normalization component for normalizing the data from the on-premise data source with data from the on-demand data source, and a combination index generation component for generating a combination index storing a mashed entity or a mashed relationship obtained from the on-premise data source and the on-demand data source.

It will be further appreciated that data indexing component 412 optionally comprises also a relevancy determination component for determining relevancy of entities in combination index 416. Data indexing component 412 may optionally comprise a second index generation component for generating a first index corresponding to the on-premise data source or a second index corresponding to the on-demand data source, such as index 1 (420) or index 2 (424).

Federated search apparatus 400 further comprises federated search component 436, responsible for searching data once the data retrieved from the data sources is fully or partially indexed.

Federated search component 436 uses combination index 416, indices 420 and 424 and optionally user context relevancy information 432 to retrieve information in response to a user-initiated query. Upon receiving a query, all indices are searched for the relevant data, and corresponding records are retrieved. The retrieved information may include retrieved mashed entities 440 which comprise information merged from two or more data sources, retrieved mashed relationships 444 which represent relationships between entities, wherein the relationships are optionally deduced from the combination of multiple data sources, such as “a person working in the same organization and living in the same city”, “a person working on a particular team and expert on a particular subject”, or the like. The retrieved data may be prioritized in accordance with relevancy information 432.

The retrieved data may be presented using presentation component 448 which may communicate with user interface 280.

It will be appreciated that in some embodiments federated search component 436 can thus comprise the following components for searching data: a scanning component for scanning the combination index in accordance with the query, a retrieving component for retrieving data from the combination index, and an output component for outputting the data.

It will be further appreciated that federated search component 436 may optionally comprise a data retrieval component for retrieving data from index 1 (420) or index 2 (424). Also, federated searching component 436 may optionally comprise a parser for parsing the query received from the user,

It will be appreciated by a person skilled in the art that the disclosed method and apparatus can also provide benefit when exploring two or more on-premise data sources, or two or more on-demand data sources. For example, the method and apparatus can be used for resolving situations that involve multiple data sources, such as locating people reporting to the same supervisor and living in the same city, which can be obtained from federating an organizational chart, and an HR database.

The disclosed method and apparatus provide the indexing and retrieval of information gathered from different sources, which may be either on-demand sources such as social networks, or on-premise sources such as HR databases, the data sources optionally having different data models.

The method and apparatus provide real-time or near-real-time and in-memory multidimensional view of the data, and federated search, including discovering unknown connections between entities. The method and apparatus comply with the underlying data sources persistency limitations.

It will be appreciated that historic data, i.e., data agathered by previous searches by the same user or by other users can be maintained and used as well, for retrieving past relations, such as a previous supervisor of an employee.

The resulting database benefits from each new user which may add new information, including entities and relationships obtained from one or more data sources.

The method and apparatus may use cloud computing or cloud storage to include data from various sources, and even share such data between organizations.

It will be appreciated by a person skilled in the art that the disclosed method and apparatus are exemplary only and that multiple other implementations and variations of the method and apparatus can be designed without deviating from the disclosure. In particular, different division of functionality into components, and different order of steps may be exercised. It will be further appreciated that components of the apparatus or steps of the method can be implemented using proprietary or commercial products.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for searching data by a computing platform from at least two computerized data sources, comprising:
an indexing stage comprising:
retrieving data from at least an on-premise data source and an on-demand data source;
identifying data related to an entity from the on-premise data source with data from the on-demand data source;
merging the data from the on-premise data source with the data from the on-demand data source;
normalizing the data from the on-premise data source with data from the on-demand data source; and
generating a first index for storing at least one mashed entity or at least one mashed relationship obtained from the on-premise data source and the on-demand data source; and
a searching stage comprising:
receiving a query from a user;
scanning the first index in accordance with the query;
retrieving data from the first index; and
outputting the data.

2. The method of claim 1 wherein the first index is stored in the memory of the computing platform.

3. The method of claim 1 wherein the indexing stage further comprises generating a second index corresponding to the on-premise data source or a third index corresponding to the on-demand data source.

4. The method of claim 3 wherein the searching stage further comprises retrieving data from the second index or the third index.

5. The method of claim 1 wherein the searching stage further comprises parsing the query received from the user.

6. The method of claim 1 wherein the indexing stage further comprises determining relevancy of entities in the first index.

7. The method of claim 1 wherein the indexing stage further comprises storing the first index in a persistent storage device in accordance with limitations imposed by the on-demand data source.

8. An apparatus for searching data from at least two sources, comprising:
a data indexing component comprising:
a retrieval component for retrieving data from at least an on-premise data source and an on-demand data source;
an identification component for identifying data related to an entity from the on-premise data source with data from the on-demand data source;
a merging component for merging the data from the on-premise data source with the data from the on-demand data source;
a normalization component for normalizing the data from the on-premise data source with data from the on-demand data source; and
a first index generation component for generating a first index comprising at least one mashed entity or at least one mashed relationship obtained from the on-premise data source and the on-demand data source, and
a searching component comprising:
a scanning component for scanning the first index in accordance with a query received from a user;
a retrieving component for retrieving data from the first index; and
an output component for outputting the data.

9. The apparatus of claim 8 wherein the first index is stored in a memory device of a computing platform executing a component of the apparatus.

10. The apparatus of claim 8 wherein the indexing component further comprises a relevancy determination component for determining relevancy of entities in the first index.

11. The apparatus of claim 8 wherein the indexing component further comprises a second index generator for generating a second index corresponding to the on-premise data source or a third index corresponding to the on-demand data source.

12. The apparatus of claim 11 wherein the searching component further comprises a data retrieval component for retrieving data from the second index or the third index.

13. The apparatus of claim 8 wherein the searching component further comprises a parser for parsing the query received from the user.

14. The apparatus of claim 8 further comprising a storage device for storing the first index in a persistent storage device in accordance with limitations imposed by the on-demand data source.

15. A computer readable storage medium containing a set of instructions for a general purpose computer, the set of instructions comprising:
an indexing stage comprising:
retrieving data from at least an on-premise data source and an on-demand data source;
identifying data related to an entity from the on-premise data source with data from the on-demand data source;
merging the data from the on-premise data source with the data from the on-demand data source;
normalizing the data from the on-premise data source with the data from the on-demand data source; and
generating a first index comprising at least one mashed entity or at least one mashed relationship obtained from the on-premise data source and the on-demand data source, and
a searching stage comprising:
receiving a query from a user;
scanning the first index in accordance with the query;
retrieving data from the first index; and
outputting the data.

16. The computer readable storage medium of claim 15 wherein the first index is stored in the memory of a computing platform executing the indexing stage.

17. The computer readable storage medium of claim 15 wherein the indexing stage further comprises generating a second index corresponding to the on-premise data source or a third index corresponding to the on-demand data source.

18. The computer readable storage medium of claim 17 wherein the searching stage further comprises retrieving data from the second index or the third index.

19. The computer readable storage medium of claim 15 wherein the searching stage further comprises parsing the query received from the user.

20. The computer readable storage medium of claim 15 wherein the indexing stage further comprises determining relevancy of entities in the first index.
